(19) United States
(12) Patent Application Publication
(10) Pub. No.: US 2026/0227204 A1
(43) Pub. Date: Aug. 6, 2026

(54) ELECTRONIC DEVICE AND METHOD FOR ACQUIRING CALIBRATION INFORMATION TO BE APPLIED TO SENSOR DATA OF GEOMAGNETIC SENSOR

(71) Applicant: SAMSUNG ELECTRONICS CO., LTD., Suwon-si (KR)

(72) Inventors: Taekeun KIM, Suwon-si (KR); Namjoon PARK, Suwon-si (KR); Sernyoung PARK, Suwon-si (KR)

(73) Assignee: SAMSUNG ELECTRONICS CO., LTD., Suwon-si (KR)

(21) Appl. No.: 19/636,238

(22) Filed: Apr. 1, 2026

Related U.S. Application Data
(63) Continuation of application No. PCT/KR2024/012536, filed on Aug. 22, 2024.

(30) Foreign Application Priority Data
Oct. 18, 2023 (KR) 10-2023-0139937
Nov. 16, 2023 (KR) 10-2023-0159010
Nov. 30, 2023 (KR) 10-2023-0171728

(51) Int. Cl. G01C 25/00; G06F 1/16

(52) U.S. Cl. CPC G01C 25/00; G06F 1/163; G06F 1/1637; G06F 1/1698

(57) ABSTRACT

A method of an electronic device including a geomagnetic sensor and a gyro sensor, includes: determining whether to change calibration information to be applied to sensor data; based on a determination to change the calibration information, identifying a state of the geomagnetic sensor and a state of the gyro sensor; based on identifying that the state of the geomagnetic sensor is an activated state and the state of the gyro sensor is a deactivated state, changing the calibration information at a first time point by using distribution of directions of a magnetic field, which are measured at a second time point; based on identifying that the state of the geomagnetic sensor is the activated state and the gyro sensor is the activated state, changing the calibration information by using the directions of the magnetic field and by using a rotation angle of the electronic device at the second time point.

### CROSS-REFERENCE TO RELATED APPLICATIONS

This application is a by-pass continuation application of International Application No. PCT/KR2024/012536, filed on Aug. 22, 2024, which is based on and claims priority to Korean Patent Application No. 10-2023-0139937, filed on Oct. 18, 2023, Korean Patent Application No. 10-2023-0159010, filed on Nov. 16, 2023, Korean Patent Application No. 10-2023-0171728, filed on Nov. 30, 2023, in the Ministry of Intellectual Property, the disclosures of which are incorporated by reference herein their entireties.

### BACKGROUND

### 1. Field

The present disclosure relates to an electronic device and a method for obtaining calibration information to be applied to sensor data of a geomagnetic sensor.

### 2. Description of Related Art

A planet such as the Earth may have a magnetic field. At any point on the Earth, a magnetic field facing a point on the Earth referred to as a geomagnetic pole may be detected. A geomagnetic sensor may output an electrical signal indicating a direction of the magnetic field (e.g., the magnetic field of the Earth) formed in an environment including the geomagnetic sensor. The direction of the magnetic field measured by the geomagnetic sensor included in an electronic device may be distorted not only by the magnetic field of the planet such as the Earth, but also by circuitry elements included in the electronic device.

The above-described information may be provided as related art for the purpose of helping understanding of the present disclosure. None of the above may be claimed as prior art associated with the present disclosure or used in decision associated with the prior art.

### SUMMARY

According to an aspect of the present disclosure, an electronic device includes: a geomagnetic sensor; a gyro sensor; memory including one or more storage media storing instructions; and at least one processor including processing circuitry, wherein the instructions, when executed by the at least one processor individually or collectively, cause the electronic device to: determine whether to change calibration information to be applied to sensor data of the geomagnetic sensor; based on a determination to change the calibration information, identify a state of the geomagnetic sensor and a state of the gyro sensor; based on identifying that the state of the geomagnetic sensor corresponds to an activated state and identifying that the state of the gyro sensor corresponds to a deactivated state, change the calibration information at a first time point by using distribution of directions of a magnetic field, which are measured by the geomagnetic sensor at a second time point that is prior to the first time point; based on identifying that the state of the geomagnetic sensor corresponds to the activated state and identifying that the gyro sensor corresponds to the activated state, change the calibration information by using the directions of the magnetic field and by using a rotation angle of the electronic device, which is measured by the gyro sensor at the second time point.

According to an aspect of the present disclosure, a method of an electronic device including a geomagnetic sensor and a gyro sensor, includes: determining whether to change calibration information to be applied to sensor data of the geomagnetic sensor; based on a determination to change the calibration information, identifying a state of the geomagnetic sensor and a state of the gyro sensor; based on identifying that the state of the geomagnetic sensor corresponds to an activated state and identifying that the state of the gyro sensor corresponds to a deactivated state, changing the calibration information at a first time point by using distribution of directions of a magnetic field, which are measured by the geomagnetic sensor at a second time point that is prior to the first time point; based on identifying that the state of the geomagnetic sensor corresponds to the activated state and identifying that the gyro sensor corresponds to the activated state, changing the calibration information by using the directions of the magnetic field and by using a rotation angle of the electronic device, which is measured by the gyro sensor at the second time point.

According to an aspect of the present disclosure, a non-transitory computer readable storage medium including instructions, wherein the instructions, when executed by a processor of an electronic device including a geomagnetic sensor and a gyro sensor, cause the electronic device to: determine whether to change calibration information to be applied to sensor data of the geomagnetic sensor; based on a determination to change the calibration information, identify a state of the geomagnetic sensor and a state of the gyro sensor; based on identifying that the state of the geomagnetic sensor corresponds to an activated state and identifying that the state of the gyro sensor corresponds to a deactivated state, change the calibration information at a first time point by using distribution of directions of a magnetic field, which are measured by the geomagnetic sensor at a second time point that is prior to the first time point; based on identifying that the state of the geomagnetic sensor corresponds to the activated state and identifying that the state of the gyro sensor corresponds to the activated state, change the calibration information by using the directions of the magnetic field and by using a rotation angle of the electronic device, which is measured by the gyro sensor at the second time point.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an exemplary operation of an electronic device measuring a direction of a magnetic field;

FIG. 2 illustrates an exemplary block diagram of an electronic device according to an embodiment;

FIG. 3 illustrates an exemplary flowchart of an electronic device according to an embodiment;

FIG. 4 illustrates an exemplary operation of an electronic device generating calibration information by using a geomagnetic sensor;

FIG. 5 illustrates an exemplary operation of an electronic device generating calibration information by using a geomagnetic sensor and a gyro sensor;

FIG. 6 is exemplary graphs representing sensor data of a geomagnetic sensor according to an exemplary motion; and

FIG. 7 is a block diagram of an electronic device in a network environment according to various embodiments.

### DETAILED DESCRIPTION

Hereinafter, various embodiments of the present document are described with reference to the accompanying drawings.

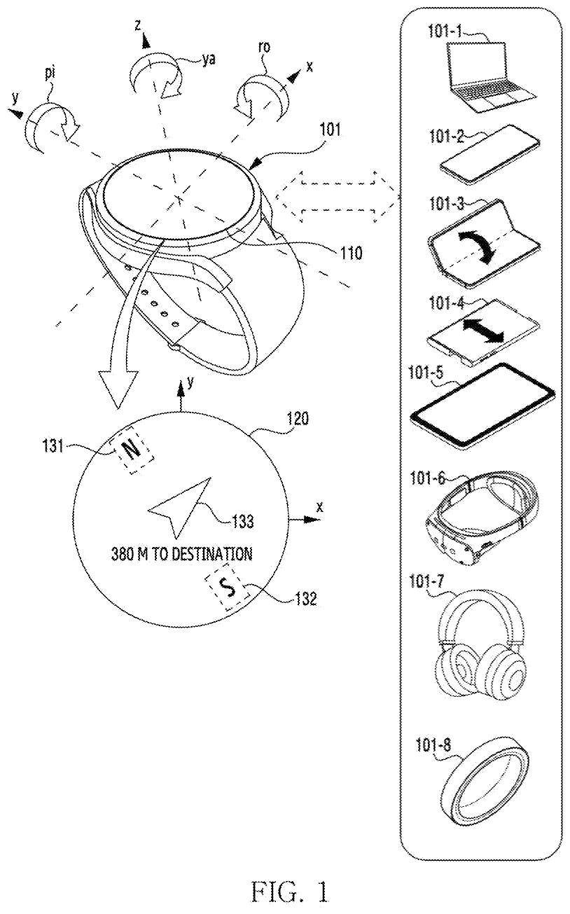

FIG. 1 illustrates an exemplary operation of an electronic device 101 measuring a direction of a magnetic field. Referring to FIG. 1, the electronic device 101 having an appearance (or an exterior) of a watch is exemplarily illustrated, but a form factor of the electronic device 101 is not limited thereto. For example, the electronic device 101 may be one of various types of electronic devices, such as a laptop personal computer (PC) 101-1, smartphones (e.g., a bar-type smartphone 101-2, a foldable-type smartphone 101-3, or a slidable (or rollable)-type smartphone 101-4), a tablet PC 101-5, a head-mounted display (HMD) device 101-6, a headset 101-7 (or a headphone), a ring 101-8, and other similar computing devices (not illustrated). The electronic device 101 may be referred to as a mobile device, a user equipment (UE) (or a user terminal), a multifunctional device, a portable communication device, a portable device, or a server. The form factor of the electronic device 101 is not limited to exemplary form factors illustrated in FIG. 1. For example, the electronic device 101 may be included as an electronic control unit (ECU) in a vehicle (e.g., an electric vehicle (EV). For example, the electronic device 101 may have a wearable form factor by a user, such as the electronic device 101 having the exterior of the watch, the headset 101-7, and/or the ring 101-8, or may have an implantable form factor in a body part of a user. An embodiment is not limited thereto, and the electronic device 101 may have a form factor of an earbud and/or a wireless earphone.

According to an embodiment, the electronic device 101 may include a sensor configured to detect terrestrial magnetism occurring on the Earth (or a planet and/or a satellite). In the present disclosure, the sensor may be referred to as a geomagnetic sensor. By using the geomagnetic sensor, the electronic device 101 may calculate or identify a direction of the electronic device 101 with respect to magnetic north. The direction may be parameterized or indicated by a numeric value such as a magnetic azimuth (or a magnetic azimuth angle). The magnetic azimuth may be measured in arc degree (°) or a unit of radian. The magnetic azimuth may correspond to an angle between a reference direction (e.g., a direction of a +y-axis in FIG. 1) of the electronic device 101 and the magnetic north detected by the geomagnetic sensor. An embodiment is not limited thereto.

Referring to FIG. 1, an exemplary state of the electronic device 101 for displaying a screen 120 associated with the geomagnetic sensor is illustrated. The screen 120 may be referred to as a user interface (UI). The electronic device 101 may detect a direction of the magnetic north based on a three-dimensional coordinate space of an x-axis, a y-axis, and a z-axis by using sensor data of the geomagnetic sensor. For example, the sensor data may include numeric values (e.g., a numeric value in a unit of tesla T and/or milli-tesla mT) corresponding to each of components (e.g., an x-axis component, a y-axis component, and a z-axis component) of a vector (e.g., a three-dimensional vector) associated with a coordinate space including exemplary three axes (the x-axis, the y-axis, and the z-axis) illustrated in FIG. 1. The numeric values may indicate intensities of a magnetic field with respect to each of the three axes.

The electronic device 101 may display, on a display 110, visual objects 131 and 132 associated with a direction detected by the geomagnetic sensor. For example, the visual object 131 may include preset text (e.g., “N”) indicating the magnetic north, and the visual object 132 may include preset text (e.g., “S”) indicating a magnetic south opposite to the magnetic north. The electronic device 101 may display the visual object 131 at a position in the display 110 corresponding to the direction of the magnetic north detected by the geomagnetic sensor. For example, a direction of the visual object 131 with respect to a center of the display 110 may correspond to the direction projected onto the display 110.

By using the direction of the electronic device 101 detected by using the geomagnetic sensor, the electronic device 101 may execute a function and/or a software application associated with a geographic location. For example, the electronic device 101 may display a UI for guiding a location spaced apart from the electronic device 101. Referring to FIG. 1, the electronic device 101 may display, on the display 110, a visual object 133 in a shape of an arrow facing a specific location. A direction in the display 110 of the visual object 133 may be associated with the direction of the electronic device 101 detected by using the geomagnetic sensor and a relative position of the electronic device 101 with respect to the location determined by using a position of the electronic device 101 detected using a global positioning system (GPS) sensor. The electronic device 101 displaying the visual object 133 may guide the user to arrive at the location in a case of moving in a direction facing the visual object 133. For example, the electronic device 101 may display, on the display 110, text (e.g., “380 m to the destination”) indicating a distance between the location and the electronic device 101.

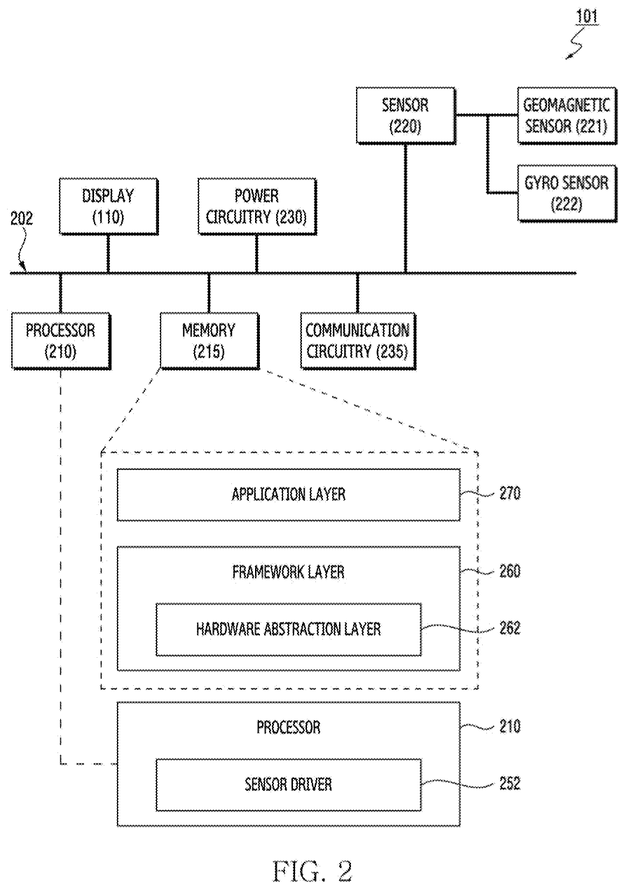

In an embodiment of detecting the direction of the electronic device 101 (e.g., a direction that may be represented by a numeric value such as the magnetic azimuth) by using the geomagnetic sensor, the direction of the magnetic north detected by the geomagnetic sensor may face a point different from the magnetic north of a planet such as the Earth, by another magnetic field different from the terrestrial magnetism. For example, the magnetic field measured by the geomagnetic sensor may be distorted not only by geomagnetic, but also by a magnetic field formed by an electronical component included in the electronic device 101 or by an external environment including the electronic device 101. According to an embodiment, the electronic device 101 may compensate for the distortion by performing calibration on sensor data outputted from the geomagnetic sensor. By compensating for the distortion, the electronic device 101 may more accurately detect or identify the direction of the magnetic north. An exemplary hardware configuration included in the electronic device 101 to compensate for the distortion will be described with reference to FIG. 2.

In an embodiment, the electronic device 101 may obtain information for the calibration of the geomagnetic sensor by using a program (or a software application) executed in a background state. For example, the electronic device 101 may obtain the information without requiring an action (e.g., an action to move the electronic device 101 along a trajectory having a shape of 8) to obtain the geomagnetic sensor. Hereinafter, performing the calibration of the geomagnetic sensor may include obtaining or generating information (hereinafter, calibration information) for the calibration of the geomagnetic sensor. Performing the calibration of the geomagnetic sensor may include obtaining or generating information used to separate a direction of the magnetic field of the Earth (or a planet and/or a satellite on which the electronic device 101 is disposed) from a direction of the magnetic field detected by the geomagnetic sensor.

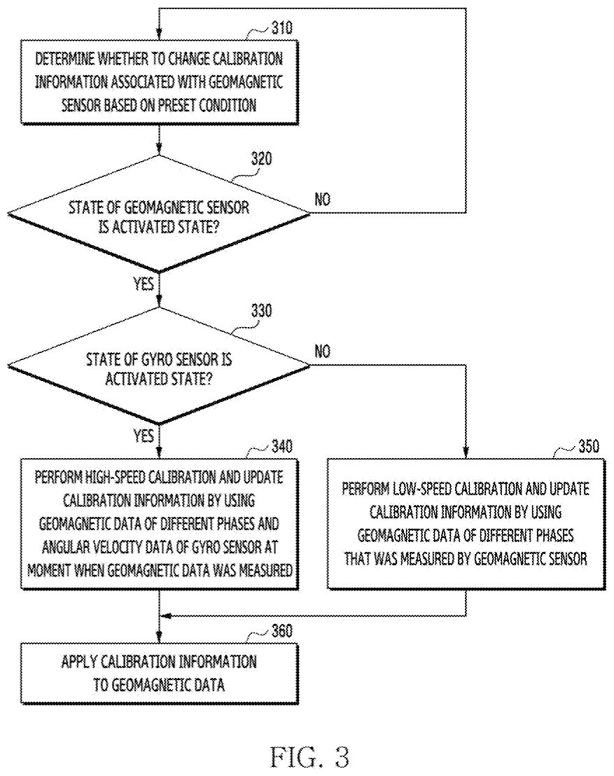

In an embodiment, the electronic device 101 may obtain information for the calibration of the geomagnetic sensor by using a gyro sensor configured to detect rotation on three axes (e.g., the x-axis, the y-axis, and the z-axis of FIG. 1). The gyro sensor may output an angular velocity of the electronic device 101 measured in rotation directions (e.g., a roll direction ro associated with the x-axis, a pitch direction pi associated with the y-axis, and a yaw direction ya associated with the z-axis) associated with each of a preset number of axes (e.g., the x-axis, the y-axis, and the z-axis exemplified in FIG. 1). For example, from the gyro sensor, the electronic device 101 may obtain or identify numeric values represented in a unit of degree/second or radian/second. According to an embodiment, an operation in which the electronic device 101 performs the calibration of the geomagnetic sensor based at least on the gyro sensor will be described with reference to FIGS. 3 to 6.

In an embodiment, the electronic device 101 may switch states of the geomagnetic sensor and the gyro sensor between an activated state (or an enabled state) or a deactivated state (or a disabled state). The activated state of an electronical component such as the geomagnetic sensor and/or the gyro sensor may include a state in which the electronical component receives a power signal having a voltage greater than a preset voltage. The activated state of the electronical component may include a state in which power consumption of the electronical component is greater than standby power. The activated state of the electronical component may include a state in which the electronical component may receive a command of a processor (e.g., an application processor (AP)) of the electronic device 101 and execute a function corresponding to the command. The activated state of the electronical component may include an idle state and/or a wake-up state of the electronical component. The activated state of the electronical component may include a short state of a port and/or a wire connected to the electronical component. The activated state of the electronical component may include a state in which a closed circuit is established between the electronical component and another electronical component.

The deactivated state of the electronical component such as the geomagnetic sensor and/or the gyro sensor may include another state different from the activated state. The deactivated state of the electronical component may include a state in which the electronical component receives a power signal having a voltage less than the preset voltage. The deactivated state of the electronical component may include a state in which power consumption of the electronical component is less than standby power or is substantially zero. The deactivated state of the electronical component may include a state in which the electronical component does not respond to a command of the processor (e.g., the AP) of the electronic device 101. The deactivated state of the electronical component may be referred to as a sleep state. The deactivated state of the electronical component may include an opened state of the port and/or the wire connected to the electronical component.

According to an embodiment, the electronic device 101 may monitor or track states of each of the geomagnetic sensor and the gyro sensor. In order to perform the calibration of the geomagnetic sensor, the electronic device 101 may repeatedly check whether the geomagnetic sensor and/or the gyro sensor corresponds to the activated state, instead of switching the geomagnetic sensor and/or the gyro sensor into the activated state. In an exemplary state of FIG. 1, while a software application associated with the geographic location is executed, the geomagnetic sensor may be switched into the activated state. In response to the geomagnetic sensor switched into the activated state, the electronic device 101 may perform the calibration of the geomagnetic sensor. Since the geomagnetic sensor and/or the gyro sensor are not actively activated, the electronic device 101 may perform the calibration of the geomagnetic sensor while preventing an increase in power consumption by the geomagnetic sensor and/or the gyro sensor.

In an embodiment, when only the geomagnetic sensor among the geomagnetic sensor and the gyro sensor is switched into the activated state, the electronic device 101 may perform the calibration of the geomagnetic sensor by using sensor data of the geomagnetic sensor. When both the geomagnetic sensor and the gyro sensor are switched into the activated state, the electronic device 101 may perform the calibration of the geomagnetic sensor by using all of sensor data of the geomagnetic sensor and the gyro sensor. In a case of performing the calibration of the geomagnetic sensor by using all of the sensor data of the geomagnetic sensor and the gyro sensor, the electronic device 101 may perform the calibration even with relatively small movement of the electronic device 101. By using the calibration, the electronic device 101 may more accurately determine or calculate the direction of the electronic device 101 (e.g., the magnetic azimuth of the electronic device 101). For example, the electronic device 101 may differently perform the calibration of the geomagnetic sensor according to a state of the gyro sensor. Since the geomagnetic sensor and/or the gyro sensor are not switched into the activated state to perform the calibration, the calibration may be performed without the increase in the power consumption of the electronic device 101.

Hereinafter, an exemplary hardware configuration included in the electronic device 101 according to an embodiment will be described with reference to FIG. 2.

FIG. 2 illustrates an exemplary block diagram of an electronic device 101 according to an embodiment. The electronic device 101 of FIG. 2 may include the electronic device 101 of FIG. 1.

Referring to FIG. 2, according to an embodiment, the electronic device 101 may include at least one of a processor 210, memory 215, a sensor 220, a display 110, power circuitry 230, or communication circuitry 235. The processor 210, the memory 215, the sensor 220, the display 110, the power circuitry 230, or the communication circuitry 235 may be electronically and/or operably coupled with each other by an electronical component such as a communication bus 202. Hereinafter, the electronical components being operably coupled may mean that a direct connection or an indirect connection between the electronical components is established by wire or wirelessly such that a second electronical component is controlled by a first electronical component among the electronical components. Although illustrated based on different blocks, an embodiment is not limited thereto, and a portion (e.g., at least a portion of the processor 210, the memory 215, and the communication circuitry 235) of the electronical components of FIG. 2 may be included in a single integrated circuit such as a system on a chip (SoC). A type and/or the number of the electronical component included in the electronic device 101 are not limited to those illustrated in FIG. 2. For example, the electronic device 101 may include only a portion of the electronical components illustrated in FIG. 2.

According to an embodiment, the processor 210 of the electronic device 101 may include circuitry for processing data based on one or more instructions. For example, the circuitry for processing the data may include an arithmetic and logic unit (ALU), a floating point unit (FPU), a field programmable gate array (FPGA), a central processing unit (CPU), and/or an application processor (AP). The number of processors 210 may be one or more. For example, the processor 210 may have a structure of a multi-core processor such as a dual core, a quad core, a hexa core, or an octa core.

According to an embodiment, the memory 215 of the electronic device 101 may include a hardware component for storing data and/or an instruction inputted to the processor 210 or outputted from the processor 210. For example, the memory 215 may include a volatile memory such as a random-access memory (RAM) and/or a non-volatile memory such as a read-only memory (ROM). For example, the volatile memory may include at least one of a dynamic RAM (DRAM), a static RAM (SRAM), a Cache RAM, and a pseudo SRAM (PSRAM). For example, the non-volatile memory may include at least one of a programmable ROM (PROM), an erasable PROM (EPROM), an electrically erasable PROM (EEPROM), a flash memory, a hard disk, a compact disk, a solid state drive (SSD), and an embedded multimedia card (eMMC).

According to an embodiment, the sensor 220 of the electronic device 101 may generate electronic information (or data) that may be processed by the processor 210 and/or the memory 215 from non-electronic information associated with the electronic device 101. For example, the sensor 220 may include a global positioning system (GPS) sensor for detecting a geographic location of the electronic device 101. In addition to the GPS method, the sensor 220, for example, may generate or output information indicating the geographic location of the electronic device 101 by using a global navigation satellite system (GNSS) such as Galileo and Beidou (compass). The information may be stored in the memory 215, processed by the processor 210, and/or transmitted to another electronic device distinct from the electronic device 101 through the communication circuitry 235. The sensor 220 is not limited to the above description, and may include an image sensor, an illuminance sensor, a proximity sensor, a fingerprint sensor, a photoplethysmogram (PPG) sensor, and/or a time-of-flight (ToF) sensor for detecting an electromagnetic wave including light.

As described above with reference to FIG. 1, the sensor 220 of the electronic device 101 may include a geomagnetic sensor 221 and/or a gyro sensor 222 for measuring physical movement of the electronic device 101. A combination of one or more sensors, including the geomagnetic sensor 221 and/or the gyro sensor 222, for measuring the physical movement of the electronic device 101 may be referred to as an inertial measurement unit (IMU). The geomagnetic sensor 221 and the gyro sensor 222 are exemplified as sensors for measuring the physical movement of the electronic device 101, but an embodiment is not limited thereto. For example, the sensor 220 of the electronic device 101 may include an acceleration sensor configured to output an electrical signal indicating gravitational acceleration and/or acceleration of each of a plurality of axes (e.g., an x-axis, a y-axis, and a z-axis).

Referring to FIG. 2, the processor 210 of the electronic device 101 may obtain, from the geomagnetic sensor 221, an electrical signal indicating magnitude of a magnetic field formed in the electronic device 101 along each of the plurality of axes (e.g., the x-axis, the y-axis, and/or the z-axis). The geomagnetic sensor 221 may convert or change an analog signal associated with the magnetic field into a digital signal by using at least one of anisotropic magnetoresistance (AMR), giant magnetoresistance (GMR), tunnel magnetoresistance (TMR), and/or planar hall resistance (PHR). In order to generate the digital signal from the analog signal, the geomagnetic sensor 221 may include an analog-to-digital converter (ADC). The geomagnetic sensor 221 may include one or more registers for storing sensitivity and/or a measurement period. The processor 210 may change the sensitivity and/or the measurement period by writing or assigning values to the one or more registers of the geomagnetic sensor 221. The measurement period may be referred to as a frame rate, a resolution, and/or a sensing period. A numeric value indicating a measurement period stored in a register may be associated with a unit of seconds and/or Hertz (Hz).

The processor 210 may obtain, from the gyro sensor 222, an electrical signal indicating an angular velocity of each of preset axes (e.g., the x-axis, the y-axis, and the z-axis of FIG. 1). The processor 210 may repeatedly obtain the electrical signals from the geomagnetic sensor 221 and/or the gyro sensor 222, based on a preset period (e.g., 1 millisecond). The electrical signals may include sensor data detected by the geomagnetic sensor 221 and/or the gyro sensor 222.

Referring to FIG. 2, the electronic device 101 may include a sensor hub as an example of a low-power processor. The sensor hub may be included in the processor 210. An embodiment is not limited thereto, and the sensor hub may be a co-processor connected to the processor 210. In terms of consuming less power than the processor 210 referred to as a CPU and/or an AP, the sensor hub may be referred to as the low-power processor. In an embodiment, a state of the sensor hub may be determined or switched independently of a state (e.g., a wake-up state and/or a sleep state) of the processor 210, such as the CPU and/or the AP. For example, while the state of the processor 210 corresponds to a deactivated state, the sensor hub may process, capture, collect, or store sensor data of the sensor 220 in an activated state.

Referring to FIG. 2, the electronic device 101 may further include the display 110, the power circuitry 230, and/or the communication circuitry 235. According to a form factor of the electronic device 101 described with reference to FIG. 1, the display 110, the power circuitry 230, and/or the communication circuitry 235 may be omitted from the electronic device 101.

According to an embodiment, the display 110 of the electronic device 101 may output visualized information (e.g., a screen 120 of FIG. 1) to a user. For example, display 110 may be configured to visualize information provided by a graphic processing unit (GPU) and/or the processor 210. The display 110 may include a liquid crystal display (LCD), a plasma display panel (PDP), and/or one or more light emitting diodes (LEDs). The LED may include an organic LED (OLED). The display 110 may include a flat panel display (FPD), and/or electronic paper. An embodiment is not limited thereto, and the display 110 may have at least a partially curved shape or a deformable shape. The display 110 having the deformable shape may be referred to as a flexible display.

In an embodiment, the electronic device 101 may include a sensor (e.g., a touch sensor panel (TSP)) for detecting an external object (e.g., a finger of the user) on the display 110. By using the TSP, the electronic device 101 may detect an external object that is in contact with the display 110 or is floating on the display 110. In response to detecting the external object, the electronic device 101 may execute a function associated with a specific visual object corresponding to a position on the display 110 of the external object among visual objects displayed in the display 110.

According to an embodiment, the power circuitry 230 of the electronic device 101 may include a means (e.g., a battery and/or a socket and/or a port for receiving an alternate current (AC) power supply) for supplying electrical energy to another electronic component (e.g., at least one of the processor 210, the display 110, the memory 215, the communication circuitry 235, or sensor 220) of the electronic device 101. For example, the power circuitry 230 may include a battery such as a lithium-ion secondary battery. For example, the power circuitry 230 may include a port (e.g., a USB-C type port), a plug, and/or a transformer for receiving electrical energy from a power distribution system such as a concentric plug. For example, the power circuitry 230 may include circuitry and/or a material for obtaining electrical energy from non-electric energy, such as a solar cell and/or a hydrogen cell.

According to an embodiment, the communication circuitry 235 of the electronic device 101 may include hardware for supporting transmission and/or reception of an electrical signal between the electronic device 101 and an external electronic device (e.g., a server and/or an access point (AP)). For example, the communication circuitry 235 may include at least one of a modem (MODEM), an antenna, and an optic/electronic (O/E) converter. The communication circuitry 235 may support transmission and/or reception of an electrical signal based on various types of protocols such as ethernet, a local area network (LAN), a wide area network (WAN), a wireless fidelity (WiFi), near field communication (NFC), Bluetooth, Bluetooth low energy (BLE), ZigBee, long term evolution (LTE), fifth-generation (5G) new radio (NR), sixth-generation (6G), and/or above-6G.

Although not illustrated, according to an embodiment, the electronic device 101 may include an output means for outputting information in a different form other than a visualized form. For example, the electronic device 101 may include a speaker for outputting an acoustic signal. For example, the electronic device 101 may include a motor for providing haptic feedback based on vibration.

Referring to FIG. 2, in the memory 215, one or more instructions (or commands) indicating a calculation and/or an operation to be performed by the processor 210 on data may be stored. A set of one or more instructions may be referred to as firm ware, an operating system, a process, a routine, a sub-routine, a program, and/or a software application (hereinafter, an application). For example, when a set of a plurality of instructions distributed in a shape of an operating system, firm ware, driver, and/or an application are executed, the electronic device 101 and/or the processor 210 may perform at least one of operations of FIG. 3. Hereinafter, an application being installed in the electronic device 101 may mean that one or more instructions provided in a shape of the application are stored in the memory 215 of the electronic device 101, and the one or more applications are stored in a format (e.g., a file with an extension preset by an operating system of the electronic device 101) executable by the processor 210 of the electronic device 101.

Referring to FIG. 2, programs installed in the memory 215 of the electronic device 101 are illustrated along different layers. By executing a sensor driver 252, the sensor hub (or the processor 210 including the sensor hub) may transmit an electrical signal to the sensor 220 such as the geomagnetic sensor 221 and/or the gyro sensor 222 or may receive an electrical signal (e.g., sensor data) from the sensor 220. For example, the sensor hub may individually control or identify states of sensors (e.g., the geomagnetic sensor 221 and/or the gyro sensor 222) included in the electronic device 101. For example, the sensor hub may receive sensor data from the sensors individually or independently.

Referring to FIG. 2, among software applications installed in the electronic device 101, software applications providing a function associated with the user of the electronic device 101 may be included in an application layer 270. Among the software applications installed in the electronic device 101, software applications providing a function for executing another software application included in the application layer 270 may be included in a framework layer 260. The processor 210 may call (or invoke), or execute functions supported by software applications included in the framework layer 260, by using an application programming interface (API) and/or a library. The software applications included in the framework layer 260 may be included in an operating system. The software applications included in the framework layer 260 may be referred to as system software and/or a system service.

Referring to FIG. 2, among the software applications installed in the electronic device 101, software applications providing a function associated with hardware of the electronic device 101 may be included in a hardware abstraction layer (HAL) 262. The processor 210 executing the software application included in the HAL 262 may obtain sensor data of the geomagnetic sensor 221 and/or the gyro sensor 222 by controlling the sensor hub. By using the sensor data, the processor 210 may obtain or generate data (e.g., data included in a data structure referred to as a rotation vector) available (or readable) by the software application installed in the electronic device 101.

In an embodiment, the sensor hub and/or the processor 210 may generate or manage calibration information associated with the geomagnetic sensor 221. The calibration information may include one or more numeric values to be applied to (or to be combined with) sensor data outputted from the geomagnetic sensor 221. The numeric values may be offset values combined with each of magnetic field components in each of three axes included in the sensor data. The sensor hub and/or the processor 210 performing calibration on the geomagnetic sensor 221 may include changing, updating, and/or generating the calibration information.

In an embodiment, the sensor hub and/or processor 210 may determine whether to change the calibration information to be applied to the sensor data of the geomagnetic sensor 221. At a specific timing, the sensor hub and/or processor 210 may check at least one condition required to change the calibration information. The at least one condition may include whether the geomagnetic sensor 221 is activated. The at least one condition identified by the sensor hub and/or the processor 210 is exemplarily described with reference to FIG. 3.

Based on a determination to change the calibration information, the sensor hub and/or processor 210 may detect or identify states of the geomagnetic sensor 221 and the gyro sensor 222. A scheme of calibrating the geomagnetic sensor 221 may be different according to the states.

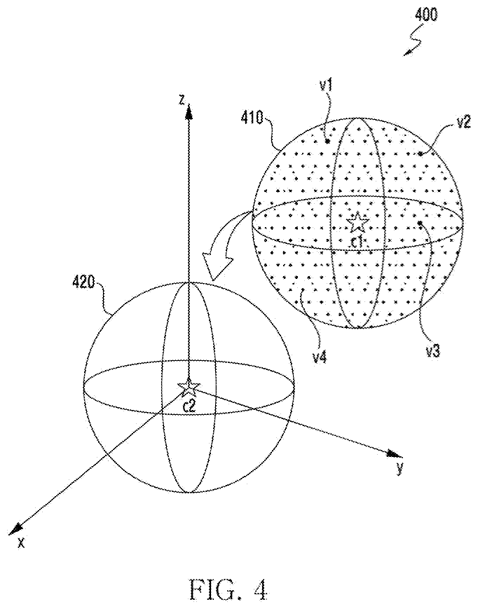

For example, based on identifying a state of the geomagnetic sensor 221 corresponding to an activated state and identifying a state of the gyro sensor 222 corresponding to a deactivated state, the sensor hub and/or the processor 210 may change the calibration information by using distribution of directions of a magnetic field that were measured by the geomagnetic sensor 221. While the geomagnetic sensor 221 among the geomagnetic sensor 221 and the gyro sensor 222 is activated, an operation of the sensor hub and/or the processor 210 for changing the calibration information will be described with reference to FIG. 4.

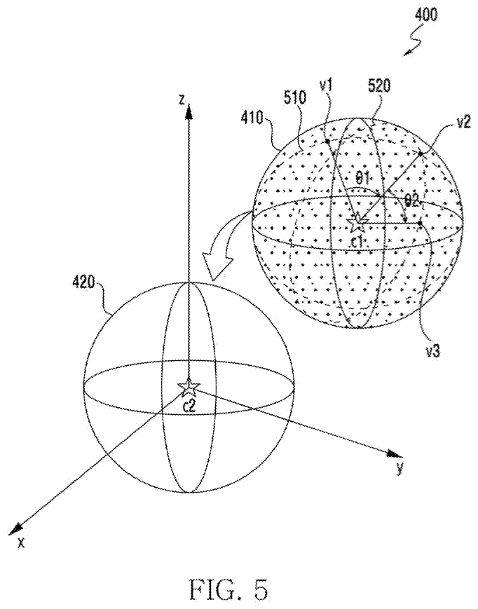

For example, based on identifying the states of the geomagnetic sensor 221 and the gyro sensor 222 corresponding to the activated state, the sensor hub and/or the processor 210 may change the calibration information by using the directions of the magnetic field that were measured by the geomagnetic sensor 221 and a rotation angle of the electronic device 101 that was measured by the gyro sensor 222 at moments (or time points) when the directions were measured. While both the geomagnetic sensor 221 and the gyro sensor 222 are activated, an operation of the sensor hub and/or the processor 210 for changing the calibration information will be described with reference to FIG. 5.

In an embodiment, the sensor hub and/or the processor 210 may manage, determine, or output a parameter (e.g., accuracy) associated with the calibration of the geomagnetic sensor 221. In the parameter, any one of preset numeric values (e.g., integers greater than or equal to 0) associated with an error in the calibration information may be stored. The error in the calibration information may be determined based on whether continuously measured sensor data of the geomagnetic sensor 221 is distributed on a reference sphere included in a three-dimensional coordinate space indicating a direction of the magnetic field. For example, the error in the calibration information may be associated with a distance between the reference sphere and a vector corresponding to the sensor data (e.g., an average of distances between each of a plurality of vectors and the reference sphere).

For example, among integers from 0 to 3, as the error in the calibration information decreases or accuracy of the calibration information increases, the sensor hub and/or the processor 210 may increase a numeric value stored in the parameter. After at a moment when the calibration information is changed, until the calibration of the geomagnetic sensor 221 is performed, an error indicated by the parameter may be gradually increased. After the moment, until the calibration of the geomagnetic sensor 221 is performed, the numeric value stored in the parameter may be gradually decreased.

In an embodiment, the sensor hub and/or the processor 210 may change a parameter indicating accuracy and/or reliability of the calibration while performing the calibration of the geomagnetic sensor 221. For example, while performing the calibration of the geomagnetic sensor 221, the sensor hub and/or the processor 210 may gradually increase the numeric value stored in the parameter among integers from 0 to 3. For example, based on completion of the calibration, the sensor hub and/or the processor 210 may store 3 in the parameter. The sensor hub and/or the processor 210 may provide the parameter indicating accuracy and/or reliability of the sensor data together with the sensor data of the geomagnetic sensor 221.

Hereinafter, an operation of the sensor hub and/or the processor 210 performed to change the calibration information associated with the geomagnetic sensor 221 will be described with reference to FIG. 3.

FIG. 3 illustrates an exemplary flowchart of an electronic device according to an embodiment. The electronic device 101 of FIGS. 1 and 2, and the processor 210 and/or the sensor hub of FIG. 2 may perform an operation described with reference to FIG. 3. Hereinafter, although the processor performs the operation of FIG. 3, an embodiment is not limited thereto, and at least one of operations of FIG. 3 may be performed by the sensor hub. The processor may cause the electronic device to perform at least one of the operations of FIG. 3 by executing instructions.

The operations of FIG. 3 may be performed without ceasing and/or switching of execution of a screen occupying a display (e.g., the display 110 of FIGS. 1 and/or 2) and/or a software application providing the screen. For example, the processor may perform at least one of the operations of FIG. 3 without ceasing execution of another program different from a program (e.g., firm ware executed by the sensor hub) for performing the operations of FIG. 3. The operations of FIG. 3 may be performed by a processor (e.g., a low-power processor such as the sensor hub) that is operated in another state (e.g., a background state) different from a foreground state interactable with a user. In a case that the processor executes a plurality of programs substantially simultaneously by using multi-tasking, the processor may perform at least one of the operations of FIG. 3 by using another software application (or a system process) in a state different from that of a software application executed to occupy the display.

Referring to FIG. 3, in an operation 310, according to an embodiment, the processor of the electronic device may determine whether to change calibration information associated with a geomagnetic sensor (e.g., the geomagnetic sensor 221 of FIG. 2) based on a preset condition. For example, the processor may check the preset condition of the operation 310 in a background state. In a case that the preset condition of the operation 310 is not satisfied, the processor may refrain from performing at least one of other operations 320, 330, 340, 350, and 360 after the operation 310. For example, in a case that the preset condition of the operation 310 is satisfied, the processor may initiate or perform the other operations 320, 330, 340, 350, and 360 after the operation 310.

In an embodiment, in the operation 310, the processor may determine whether to change the calibration information by using one or more preset conditions. In an embodiment of identifying a plurality of preset conditions, in a case that all of the plurality of preset conditions or conditions greater than a preset threshold are satisfied, the processor may initiate or perform the other operations 320, 330, 340, 350, and 360 after the operation 310. Hereinafter, the preset condition of the operation 310 will be exemplarily described. The processor may selectively check only one of conditions to be described later. An embodiment is not limited thereto, and exemplary conditions to be described below may be sequentially checked by the processor and/or may be checked substantially simultaneously.

In an embodiment, the preset condition of the operation 310 may be associated with a preset period. For example, in response to expiration of the preset period, the processor may perform the operation 310. The processor may determine to change the calibration information of the operation 310 per the preset period. The preset period may be adaptively set or adjusted by the processor.

For example, the processor may change the preset period associated with the preset condition of the operation 310 by using a state of a battery included in the power circuitry 230 of FIG. 2. For example, the processor may change the preset period by using a state of charge (SOC) of the battery. In a case that the SOC is less than a preset threshold (e.g., a threshold indicating a low-power state), the processor may increase or extend the preset period to reduce power consumption by calibration. While charging the battery, or in response to the SOC greater than or equal to the preset threshold, the processor may reduce the preset period.

In an embodiment, the preset condition of the operation 310 may be associated with a position of the electronic device including the processor. For example, by using the position of the electronic device identified by using a GPS sensor, the processor may determine whether to change the calibration information. For example, in a case that the electronic device is positioned in a location different from a location (e.g., a home and/or a company of the user) associated with the user (or the user logged into the electronic device) who owns the electronic device, a probability that an application (e.g., a map application and/or a navigation application) associated with the geomagnetic sensor executed by the user may increase. In the example, the processor may determine to change the calibration information by using whether the position of the electronic device is different from the location (or a location registered by the user) associated with the user. For example, the processor that detects the position of the electronic device included in a location different from a location previously registered by the user may determine to change the calibration information.

In an embodiment, the preset condition of the operation 310 may be associated with a state of the user (or the user logged into the electronic device) who owns the electronic device including the processor. The processor may determine whether to change the calibration information by using a parameter associated with the state of the user. The parameter may indicate one category corresponding to a current state of the user among categories (e.g., daily life, sleep, sitting, standing, walking, running, and/or exercise) for classifying the state of the user. The processor may determine or change the parameters by using sensor data of a sensor (e.g., the sensor 220 of FIG. 2), current time, a current position of the electronic device, a software application executed by the electronic device and/or a user input detected by the software application.

For example, in a case that the current state of the user indicated by the parameter changes from a first category corresponding to sleep to a second category corresponding to daily life, a probability that the user executes a function associated with the geomagnetic sensor may increase. In the example, the processor may more frequently perform calibration of the geomagnetic sensor by reducing a period of checking the preset condition of the operation 310. For example, in a case that the current state of the user indicated by the parameter corresponds to the first category, the probability that the user executes the function may be reduced. In the example, the processor may perform the calibration of the geomagnetic sensor less frequently by increasing the period of checking the preset condition of the operation 310.

In an embodiment, the preset condition of the operation 310 may be associated with a state of the electronic device including the processor. For example, the preset conditions may include whether a display (e.g., the display 110 of FIGS. 1 and/or 2) of the electronic device is activated and/or whether the software application being executed by the electronic device is associated with the geomagnetic sensor and/or a gyro sensor. For example, in a case that the display is activated, since the probability that a software application associated with the geomagnetic sensor is executed by the user increases, the processor may determine to change the calibration information or reduce the period of checking the preset condition of the operation 310. For example, in a case that text (or a preset flag) indicating that the geomagnetic sensor and/or the gyro sensor are used is included in metadata (e.g., an extended marked-up language (xml) file named “manifest”) of the software application executed by the electronic device, the processor may determine to perform the calibration of the geomagnetic sensor or reduce the period of checking the preset condition of the operation 310.

The processor checking the preset condition of the operation 310 may perform an operation 320 in a case that the preset condition is satisfied. In the operation 320, according to an embodiment, the processor of the electronic device may check or determine whether a state of the geomagnetic sensor is an activated state. The processor may check the state of the geomagnetic sensor based on whether the geomagnetic sensor outputs sensor data. For example, in the activated state, the geomagnetic sensor may periodically or repeatedly output the sensor data. In the example, in response to the sensor data received from the geomagnetic sensor, the processor may determine that the state of the geomagnetic sensor corresponds to the activated state. In the example, in a case that the sensor data is not received for a duration greater than a preset duration, the processor may determine that the state of the geomagnetic sensor corresponds to a deactivated state.

For example, the processor may check the state of the geomagnetic sensor by using a register (e.g., the sensor hub and/or the register of the processor 210 of FIG. 2) of the processor in which a value indicating the state of the geomagnetic sensor is stored. For example, at a timing when the geomagnetic sensor is activated, the processor may store, in the register, a preset numeric value indicating that the state of the geomagnetic sensor corresponds to the activated state. In a case of obtaining the preset numeric value from the register, the processor may identify or check the state of the geomagnetic sensor corresponding to the activated state. In a case that another numeric value (e.g., a preset numeric value corresponding to the deactivated state) different from the preset numeric value is obtained from the register, the processor may identify or check the state of the geomagnetic sensor corresponding to the deactivated state.

In response to the state of the geomagnetic sensor corresponding to the deactivated state (320—NO), the processor may refrain from performing other operations 330, 340, 350, and 360 of FIG. 3 after the operation 320. For example, the processor that checks the state of the geomagnetic sensor corresponding to the deactivated state may at least temporarily cease or bypass changing the calibration information.

Referring to FIG. 3, in a case that the state of the geomagnetic sensor is the activated state (320—YES), the processor may perform an operation 330. For example, while the geomagnetic sensor is switched into the activated state by a foreground software application occupying the display (e.g., the display 110 of FIGS. 1 and/or 2) of the electronic device, the processor may identify a state of the gyro sensor (e.g., the gyro sensor 222 of FIG. 2) by using the operation 330. In a case that a software application executed by the processor is associated with the geomagnetic sensor or is set to use the geomagnetic sensor, the processor may determine that the state of the geomagnetic sensor corresponds to the activated state. For example, based on whether the software application executed by the processor is associated with the geomagnetic sensor, the processor may determine whether to change the calibration information.

Referring to FIG. 3, in the operation 330, according to an embodiment, the processor of the electronic device may check or determine whether the state of the gyro sensor is the activated state. The processor may check the state of the gyro sensor based on whether the gyro sensor outputs sensor data. For example, the gyro sensor in the activated state may periodically or repeatedly output the sensor data. In the example, in response to the sensor data received from the gyro sensor, the processor may determine that the state of the gyro sensor corresponds to the activated state. In the example, the processor that has not received the sensor data for a period greater than a preset duration may determine that the state of the gyro sensor corresponds to the deactivated state.

For example, the processor may check the state of the gyro sensor by using the register of the processor in which a value indicating the state of the gyro sensor is stored. The processor may store a first value indicating the activated state in the register at a timing of activating the gyro sensor, and a second value indicating the deactivated state in the register at another timing of deactivating the gyro sensor. The processor that has loaded the first value from the register may determine that the gyro sensor corresponds to the activated state. The processor that has obtained the second value from the register may determine that the gyro sensor corresponds to the deactivated state.

In response to the state of the gyro sensor corresponding to the deactivated state (330—NO), the processor may perform an operation 350. In response to the state of the gyro sensor corresponding to the activated state (330—YES), the processor may perform an operation 340. Referring to the operations 320 and 330 of FIG. 3, the processor may check the state of the gyro sensor while the state of the geomagnetic sensor corresponds to the activated state.

Referring to FIG. 3, in the operation 340, according to an embodiment, the processor of the electronic device may change the calibration information by using the sensor data of the geomagnetic sensor and the gyro sensor. For example, the processor may perform high-speed calibration and update the calibration information by using geomagnetic data of different phases that was measured by the geomagnetic sensor and angular velocity data of the gyro sensor at a moment when the geomagnetic data was measured. The processor may obtain or generate the calibration information by fusing the sensor data of the gyro sensor and the sensor data of the geomagnetic sensor. A scheme of changing the calibration information by using both the geomagnetic sensor and the gyro sensor may be referred to as a high-speed calibration scheme. By using the gyro sensor, the processor may obtain or generate the calibration information from relatively little movement of the electronic device. An operation of the processor that changes the calibration information by using the sensor data of both the geomagnetic sensor and the gyro sensor will be described with reference to FIG. 5.

Referring to FIG. 3, in the operation 350, according to an embodiment, the processor of the electronic device may change the calibration information by using the sensor data of the geomagnetic sensor among the geomagnetic sensor or the gyro sensor. For example, the processor may perform low-speed calibration and update the calibration information by using geomagnetic data of different phases that was measured by the geomagnetic sensor. In a case that the gyro sensor is in the deactivated state, the processor may change the calibration information by using only the sensor data of the geomagnetic sensor. A scheme of changing the calibration information by using the sensor data of the geomagnetic sensor among the geomagnetic sensor or the gyro sensor may be referred to as a low-speed calibration scheme. An operation of the processor that changes the calibration information by using only the geomagnetic sensor will be described with reference to FIG. 4.

The calibration information changed or generated by the operations 340 and 350 of FIG. 3 may be stored in at least one of the processor 210, the sensor hub, and/or the memory 215 of FIG. 2. The processor may selectively perform any one of the operations 340 and 350 according to each of the states of the geomagnetic sensor and/or the gyro sensor without changing the state of the geomagnetic sensor and/or the gyro sensor to the activated state. Since the states of the geomagnetic sensor and the gyro sensor are not actively changed, power consumed to change the calibration information may be optimized. Since the calibration information is changed in the background state, the electronic device may execute a software application associated with the geomagnetic sensor by using the updated calibration information.

After performing at least one of the operations 340 and 350, in an operation 360, according to an embodiment, the processor of the electronic device may perform the calibration on the sensor data by applying the calibration information changed to the sensor data (e.g., the geomagnetic data) of the geomagnetic sensor. For example, the processor may obtain or generate valid geomagnetic data that may obtain azimuth information of the electronic device, by applying (or compensating for) the calibration information to the geomagnetic data obtained from the geomagnetic sensor. For example, the processor may perform the calibration of the operation 360 by combining, adding, or subtracting the calibration information with, to, or from the sensor data of the geomagnetic sensor. For example, after changing the calibration information by performing at least one of the operations 340 and 350, the processor may generate or provide the sensor data combined with the changed calibration information in response to an event for accessing the sensor data of the geomagnetic sensor. The event may occur based on execution of a software application designed to use the geomagnetic sensor, or may occur by a user input for executing the software application. By using the operation 360, the processor may compensate for distortion included in the sensor data of the geomagnetic sensor, such as hard iron (or soft iron). By using the sensor data compensated for the distortion, the processor may execute a function (e.g., a function provided by a software application installed in the electronic device) associated with the geomagnetic sensor.

For example, before executing the software application associated with the geomagnetic sensor, the processor may update the calibration information by using the operations of FIG. 3. By executing the software application using the updated calibration information, the processor may provide the user who has executed the software application with an accurate magnetic north direction and/or with a user experience associated with the magnetic north direction.

As described above, by using the operations of FIG. 3 performed in the background state, the processor may change or generate the calibration information by using an unintended motion of the user. In order to minimize power consumed for the calibration, the processor may adaptively change the calibration information according to the state of the geomagnetic sensor and the state of the gyro sensor without activating the geomagnetic sensor and/or the gyro sensor. In order to quickly change the calibration information, the processor may further use the sensor data of the gyro sensor.

Hereinafter, an operation of the processor that changes the calibration information by using the sensor data of the geomagnetic sensor and/or the gyro sensor will be exemplarily described with reference to FIGS. 4 and 5.

FIG. 4 illustrates an exemplary operation of an electronic device generating calibration information by using a geomagnetic sensor (e.g., the geomagnetic sensor 221 of FIG. 2). The electronic device 101 of FIGS. 1 and 2, and the processor 210 and/or the sensor hub of FIG. 2 may perform the operation of the electronic device described with reference to FIG. 4. The operation of the electronic device described with reference to FIG. 4 may be associated with the operation 350 of FIG. 3.

In an embodiment, the electronic device identifying a state of a geomagnetic sensor (e.g., the geomagnetic sensor 221 of FIG. 2) corresponding to an activated state and a state of a gyro sensor (e.g., the gyro sensor 222 of FIG. 2) corresponding to a deactivated state may perform calibration on the geomagnetic sensor by using distribution of directions of a magnetic field that was measured by the geomagnetic sensor. Referring to FIG. 4, in a coordinate space 400 based on an x-axis, a y-axis, and a z-axis perpendicular to each other, sensor data of the geomagnetic sensor may be mapped to any one point (or vector) in the coordinate space 400. For example, the sensor data of the geomagnetic sensor may include values indicating intensities of a magnetic field with respect to each of the x-axis, the y-axis, and the-axis. A combination of the values may correspond to a coordinate indicating a specific point in the coordinate space 400. The x-axis, the y-axis, and the z-axis of FIG. 4 may correspond to each of the x-axis, y-axis, and z-axis formed based on the electronic device 101 of FIG. 1 in a reference direction associated with a direction of the magnetic field detected by the geomagnetic sensor.

Since the electronic device is moved by an external force and/or a motion of a user who owns the electronic device, the direction of the magnetic field detected by the geomagnetic sensor may change according to time. While the electronic device is changed or rotated, a relative positional relationship of electronical components (e.g., the electronical components including the geomagnetic sensor 221 of FIG. 2) included in the electronic device may not be changed. Since the relative positional relationship of the electronical components is not changed, the magnetic field detected by the geomagnetic sensor is a fixed component and may include a magnetic field generated by other electronical components in the electronic device different from the geomagnetic sensor. For example, in a case that the electronic device is moved or rotated, among components of the magnetic field detected by the geomagnetic sensor, only magnetic field of the Earth may be changed and another magnetic field may not be changed.

Referring to FIG. 4, exemplary distribution of directions of the magnetic field that was measured by the geomagnetic sensor at different timings is illustrated. In a case that the directions are displayed as dots in the coordinate space 400, the dots may have a shape of a sphere 410. For example, the distribution of the directions that was measured by the geomagnetic sensor may have a shape of a spherical surface (or a surface of a sphere). According to an embodiment, the electronic device may determine or identify, from directions represented by three-dimensional vectors, a center point c1 of a spherical surface at which the three-dimensional vectors are positioned. For example, by using an equation of a sphere such as Equation 1, the electronic device may calculate or obtain a coordinate in the coordinate space 400 of the center point c1. The center point c1 may be referred to as hard iron.

$${( x - a )}^{2} + {( y - b )}^{2} + {( z - c )}^{2} = {r}^{2} \qquad [ Equation 1 ]$$

The a, b, and c of Equation 1 may correspond to the coordinate of the center point c1. The r in Equation 1 may correspond to a radius of the sphere 410. The constants a, b, c, and r of Equation 1 may be calculated or obtained from simultaneous equations derived from at least four directions (e.g., vectors of v1, v2, v3, and v4) in distribution of directions having a shape of the sphere 410. For example, the electronic device may obtain or calculate the coordinate of the center point c1 by using at least four directions that were measured by the geomagnetic sensor at least four time points. In the example, in order to more accurately calculate the constants a, b, c, and r, four directions spaced apart from each other by greater than a preset distance in the coordinate space 400 may be selected.

In an embodiment, the electronic device calculating the center point c1 of the sphere 410 from the distribution of the directions that has the shape of the sphere 410 and that was measured by the geomagnetic sensor may store a three-dimensional vector (e.g., the a, b, and c in Equation 1) representing the center point c1 as calibration information of the operation 350. After calculating the center point c1, a processor may perform calibration on sensor data by combining the calibration information associated with the center point c1 with the sensor data of the geomagnetic sensor. For example, in a case that the sensor data is a vector represented by x, y, or z, the processor may output a vector represented by x-a, y-b, or z-c as a vector indicating a magnetic north direction detected by the geomagnetic sensor.

For example, since the sensor data outputted from the geomagnetic sensor is adjusted by using the coordinate of the center point c1, the adjusted sensor data may have distribution of a sphere 420 based on a center point c2 that corresponds to an origin point or is adjacent to an origin point in the coordinate space 400. A radius of the sphere 420 may be substantially the same as a radius of the sphere 410. For example, by using the coordinate of the center point c1, the processor may move, in parallel, the magnetic north direction indicated by the sensor data of the geomagnetic sensor in the coordinate space 400. By using the parallel movement, the processor may more accurately represent the magnetic north direction based on the origin point of the coordinate space 400.

As described above, in a case that calibration is performed by using the geomagnetic sensor among the geomagnetic sensor or the gyro sensor, the electronic device may obtain calibration information in a low-speed calibration scheme that solves simultaneous equations. In a case that directions indicated by the sensor data of the geomagnetic sensor have the distribution of the sphere 410, the electronic device may select directions spaced apart from each other on a surface of the sphere 410 as directions to be used to obtain the calibration information. Since deviation (or variance) of the directions detected by the geomagnetic sensor is reduced in a case that the electronic device is relatively less moved or rotated, the electronic device does not sufficiently select the directions to be used to calculate the calibration information. In the case, the electronic device may request the user for a motion of the electronic device following rapid movement, rapid rotation, and/or a relatively large length and/or preset trajectory (e.g., a trajectory in a shape of 8) of the electronic device. The request may be provided or output to the user through at least one of a display, a speaker, and/or a haptic motor included in the electronic device.

FIG. 5 illustrates an exemplary operation of an electronic device generating calibration information by using a geomagnetic sensor (e.g., the geomagnetic sensor 221 of FIG. 2) and a gyro sensor (e.g., the gyro sensor 222 of FIG. 2). The electronic device 101 of FIGS. 1 and 2, and the processor 210 and/or the sensor hub of FIG. 2 may perform the operation of the electronic device described with reference to FIG. 5. The operation of the electronic device described with reference to FIG. 5 may be associated with the operation 340 of FIG. 3.

In an embodiment, the electronic device identifying states of the geomagnetic sensor (e.g., the geomagnetic sensor 221 of FIG. 2) and the gyro sensor (e.g., the gyro sensor 222 of FIG. 2) corresponding to an activated state may estimate or identify a sphere 410 represented by three-dimensional vectors indicating directions detected by the geomagnetic sensor in a coordinate space 400, by using a direction of a magnetic field detected by the geomagnetic sensor at a specific moment and a rotation angle of the electronic device detected by the gyro sensor at the specific moment. The coordinate space 400 of FIG. 5 may correspond to the coordinate space 400 of FIG. 4. An x-axis, a y-axis, and a z-axis of FIG. 5 may correspond to each of the x-axis, the y-axis, and the z-axis formed based on the electronic device 101 of FIG. 1.

In an example case of FIG. 5, a direction of a magnetic field detected by the geomagnetic sensor at a first moment may correspond to a vector v1, a direction of a magnetic field detected by the geomagnetic sensor at a second moment after the first moment may correspond to a vector v2, and a direction of a magnetic field detected by the geomagnetic sensor at a third moment after the second moment may correspond to a vector v3. The electronic device may calculate or identify a rotation angle Q1 of the electronic device between the first moment and the second moment by using the gyro sensor. The electronic device may obtain or identify a rotation angle Q2 of the electronic device between the second moment and the third moment by using the gyro sensor.

In an exemplary case of FIG. 5, the electronic device may determine, identify, or obtain a circle 510 where the vector v1 and the vector v2 are positioned by using the rotation angle Q1. The circle 510 may be formed based on a center point c1 estimated by the vector v1, the vector v2, and the rotation angle Q1. Obtaining the circle 510 by the electronic device may include obtaining information (e.g., the center point c1 of the circle 510 and/or a radius of the circle 510) for specifying the circle 510 in the coordinate space 400. The electronic device may obtain the circle 510 by moving or rotating the vector v1 and/or the vector v2 using the rotation angle Q1. Similarly, the electronic device may obtain a circle 520 by using the vector v2, the vector v3, and the rotation angle Q2.

Referring to FIG. 5, by using the circles 510 and 520 obtained by the vectors v1, v2, and v3 and the rotation angles Q1 and Q2, the electronic device may identify or obtain the sphere 410 where all of the vectors v1, v2, and v3 are positioned. The electronic device may store a coordinate of the center point c1 of the sphere 410 including the circles 510 and 520 as calibration information. Referring to FIG. 4, the electronic device using the geomagnetic sensor among the geomagnetic sensor or the gyro sensor may use at least four vectors spaced apart from each other to obtain the coordinate of the center point c1. As described above with reference to FIG. 5, the electronic device may obtain or calculate the coordinate of the center point c1 by using at least three vectors. Since the sphere 410 and/or the circles 510 and 520 included in the sphere 410 are estimated by using the rotation angle (e.g., Q1 and/or Q2), the electronic device may obtain or calculate the coordinate of the center point c1 with only vectors spaced along a relatively short distance. In a case that sensor data in which the coordinate of the center point c1 are combined is outputted, distribution of magnetic north directions indicated by the sensor data may be formed based on the center point c2 adjacent to an origin point or corresponding to an origin point in the coordinate space 400.

As described above, the electronic device may be relatively little moved by using the gyro sensor as well as the geomagnetic sensor or obtain the calibration information from a motion of the rotated electronic device. For example, a high-speed calibration scheme by using both the geomagnetic sensor and the gyro sensor may be completed faster than a low-speed calibration scheme. For example, the high-speed calibration scheme may require less motion of the electronic device than the low-speed calibration scheme. For example, the electronic device performing the high-speed calibration scheme may change or obtain the calibration information by using a small motion of the electronic device caused in everyday life.

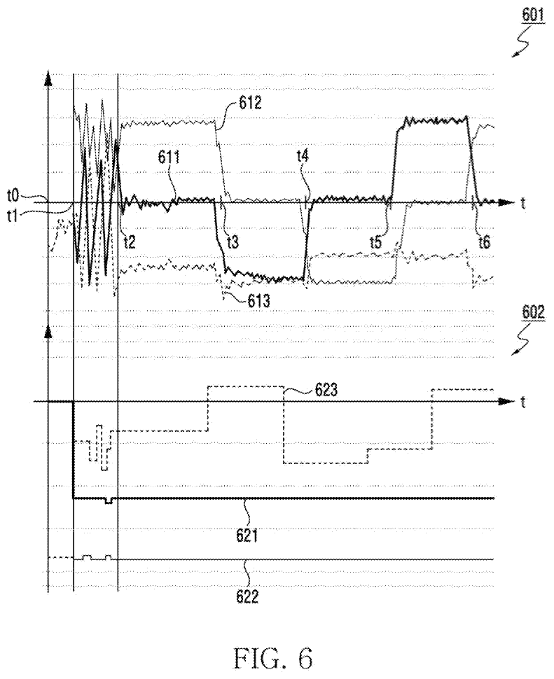

Hereinafter, an experimental graph for the high-speed scheme method and the low-speed calibration scheme described with reference to FIGS. 3 to 5 will be described with reference to FIG. 6.

FIG. 6 is exemplary graphs representing sensor data of a geomagnetic sensor (e.g., the geomagnetic sensor 221 of FIG. 2) according to an exemplary motion. The electronic device 101 of FIGS. 1 and 2, and the processor 210 and/or the sensor hub of FIG. 2 may perform an operation of the electronic device described with reference to FIG. 6.

Referring to FIG. 6, a graph 601 indicating numeric values (e.g., numeric values indicating intensities of a magnetic field with respect to each of an x-axis, a y-axis, and a z-axis) included in sensor data of a geomagnetic sensor in a time domain and a graph 602 indicating numeric values (e.g., x-axis, y-axis, and z-axis coordinate values of the center point c1 of FIGS. 4 and 5) included in calibration information in a time interval synchronized with the graph 601 are exemplarily illustrated. Horizontal axes of the graphs 601 and 602 may be time axes in a unit of seconds. Vertical axes of the graphs 601 and 602 may be axes for indicating a magnetic field intensity (e.g., a magnetic field intensity having a unit of milli-tesla).

In the graph 601 of FIG. 6, a line 611 indicates an intensity of a magnetic field with respect to the x-axis, a line 612 indicates an intensity of a magnetic field with respect to the y-axis, and a line 613 indicates an intensity of a magnetic field with respect to the z-axis. According to an exemplary motion of the electronic device performed after a moment to, the sensor data of the geomagnetic sensor which is indicated by the lines 611, 612, and 613 may be changed. For example, in a first time interval between the moment t0 and a moment t2, a user may move the electronic device along an exemplary path having a shape of 8. In a second time interval between the moment t2 and a moment t3, the user may move the electronic device such that a first surface of the electronic device faces magnetic north. In a third time interval between the moment t3 and a moment t4, the user may move the electronic device such that a second surface perpendicular to the first surface faces the magnetic north by rotating the electronic device by 90°. In a fourth time interval between the moment t4 and a moment t5, the user may move the electronic device such that a third surface opposite to the first surface faces the magnetic north by rotating the electronic device by 90°. In a fifth time interval between the moment t5 and a moment t6, the user may move the electronic device such that a fourth surface opposite to the second surface faces the magnetic north by rotating the electronic device by 90°. The first surface to the fourth surface may be referred to as a side surface (e.g., another surface connected to a front surface of the electronic device on which a display is disposed).

Referring to FIG. 6, at the moment t0, the electronic device may determine to perform calibration of the geomagnetic sensor according to the operation 310 of FIG. 3. By using the sensor data of the geomagnetic sensor accumulated, collected, or stored after the moment to, the electronic device may obtain or generate calibration information. In a case that the gyro sensor (e.g., the gyro sensor 222 of FIG. 2) is activated at the moment t0 when it is determined to perform the calibration of the geomagnetic sensor, the electronic device may obtain the calibration information by further using sensor data of the gyro sensor (e.g., the high-speed calibration scheme described with reference to FIG. 5). In a case that the gyro sensor is deactivated at the moment t0, the electronic device may obtain the calibration information by using only the sensor data of the geomagnetic sensor (e.g., the low-speed calibration scheme described with reference to FIG. 4).

Referring to FIG. 6, in the graph 602, a line 621 indicates a first numeric value to be applied to an intensity of the magnetic field with respect to the x-axis of sensor data among numeric values included in the calibration information. A line 622 indicates a second numeric value to be combined with an intensity of the magnetic field with respect to the y-axis of the sensor data, among the numeric values included in the calibration information. A line 623 indicates a third numeric value to be added to an intensity (or subtracted from the intensity) of the magnetic field with respect to the z-axis of the sensor data, among the numeric values included in the calibration information. A combination of the first numeric value, the second numeric value, and the third numeric value may correspond to a coordinate of the center point c1 of a sphere (e.g., the sphere 410 of FIGS. 4 and/or 5) indicated by distribution of the sensor data of the geomagnetic sensor indicated by the lines 611, 612, and 613.

Referring to FIG. 6, in a case that the gyro sensor is activated, the electronic device determined to perform the calibration of the geomagnetic sensor at the moment t0 may complete the calibration at the moment t1 after the moment t0. The electronic device detecting a state of the gyro sensor corresponding to an activated state may perform the calibration by using the high-speed calibration scheme. For example, at the moment t1, a parameter (e.g., accuracy and/or reliability) associated with calibration outputted by the sensor hub and/or the processor (e.g., the processor 210 of FIG. 2) of the electronic device may correspond to a preset numeric value (e.g., 3) indicating completion of the calibration. After the moment point t1, the electronic device may output the sensor data of the geomagnetic sensor to which the calibration information indicated by the lines 621, 622, and 623 is applied in a magnetic north direction detected by the geomagnetic sensor.

In an embodiment, in a case that the gyro sensor is deactivated, the electronic device determined to perform the calibration of the geomagnetic sensor at the moment t0 may complete the calibration at a moment after the moment to. The electronic device detecting the state of the gyro sensor corresponding to a deactivated state may perform the calibration by using the low-speed calibration scheme. In a case performing the low-speed calibration scheme, at the moment t1, a parameter associated with the calibration outputted by the sensor hub and/or the processor of the electronic device may correspond to another numeric value less than the preset numeric value.

As described above, according to an embodiment, the electronic device may complete the calibration by using the sensor data collected from the geomagnetic sensor in a relatively small time interval (e.g., a time interval between the moment t0 and the moment t1) by using the gyro sensor. In order to reduce power consumed for the calibration, the electronic device may continuously (or repeatedly) monitor the states of the gyro sensor and/or the geomagnetic sensor, and may determine or select a scheme (e.g., the high-speed calibration scheme and/or the low-speed calibration scheme) associated with the calibration according to the monitored states.

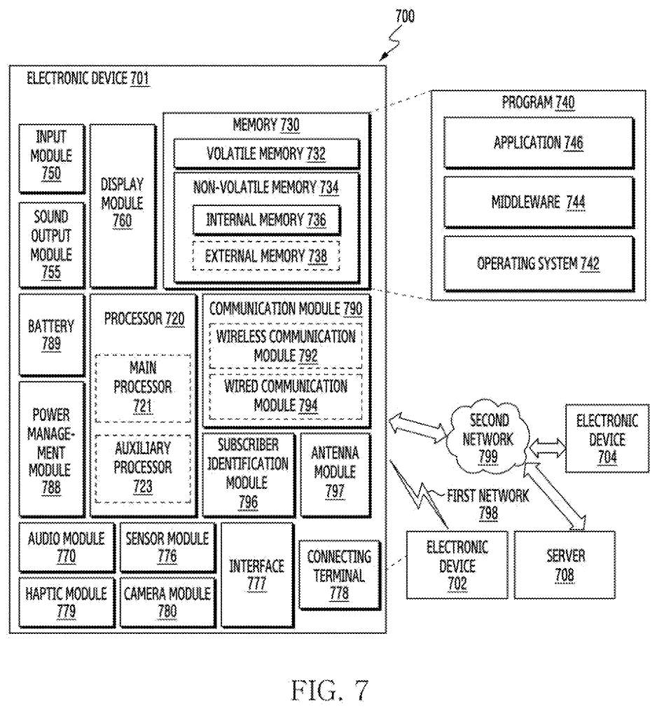

Hereinafter, an example of the electronic device described with reference to FIGS. 1 to 6 will be described with reference to FIG. 7.

FIG. 7 is a block diagram illustrating an electronic device 701 in a network environment 700 according to various embodiments. Referring to FIG. 7, the electronic device 701 in the network environment 700 may communicate with an electronic device 702 via a first network 798 (e.g., a short-range wireless communication network), or at least one of an electronic device 704 or a server 708 via a second network 799 (e.g., a long-range wireless communication network). According to an embodiment, the electronic device 701 may communicate with the electronic device 704 via the server 708. According to an embodiment, the electronic device 701 may include a processor 720, memory 730, an input module 750, a sound output module 755, a display module 760, an audio module 770, a sensor module 776, an interface 777, a connecting terminal 778, a haptic module 779, a camera module 780, a power management module 788, a battery 789, a communication module 790, a subscriber identification module (SIM) 796, or an antenna module 797. In some embodiments, at least one of the components (e.g., the connecting terminal 778) may be omitted from the electronic device 701, or one or more other components may be added in the electronic device 701. In some embodiments, some of the components (e.g., the sensor module 776, the camera module 780, or the antenna module 797) may be implemented as a single component (e.g., the display module 760).

The processor 720 may execute, for example, software (e.g., a program 740) to control at least one other component (e.g., a hardware or software component) of the electronic device 701 coupled with the processor 720, and may perform various data processing or computation. According to an embodiment, as at least part of the data processing or computation, the processor 720 may store a command or data received from another component (e.g., the sensor module 776 or the communication module 790) in volatile memory 732, process the command or the data stored in the volatile memory 732, and store resulting data in non-volatile memory 734. According to an embodiment, the processor 720 may include a main processor 721 (e.g., a central processing unit (CPU) or an application processor (AP)), or an auxiliary processor 723 (e.g., a graphics processing unit (GPU), a neural processing unit (NPU), an image signal processor (ISP), a sensor hub processor, or a communication processor (CP)) that is operable independently from, or in conjunction with, the main processor 721. For example, when the electronic device 701 includes the main processor 721 and the auxiliary processor 723, the auxiliary processor 723 may be adapted to consume less power than the main processor 721, or to be specific to a specified function. The auxiliary processor 723 may be implemented as separate from, or as part of the main processor 721.

The auxiliary processor 723 may control at least some of functions or states related to at least one component (e.g., the display module 760, the sensor module 776, or the communication module 790) among the components of the electronic device 701, instead of the main processor 721 while the main processor 721 is in an inactive (e.g., sleep) state, or together with the main processor 721 while the main processor 721 is in an active state (e.g., executing an application). According to an embodiment, the auxiliary processor 723 (e.g., an image signal processor or a communication processor) may be implemented as part of another component (e.g., the camera module 780 or the communication module 790) functionally related to the auxiliary processor 723. According to an embodiment, the auxiliary processor 723 (e.g., the neural processing unit) may include a hardware structure specified for artificial intelligence model processing. An artificial intelligence model may be generated by machine learning. Such learning may be performed, e.g., by the electronic device 701 where the artificial intelligence is performed or via a separate server (e.g., the server 708). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 730 may store various data used by at least one component (e.g., the processor 720 or the sensor module 776) of the electronic device 701. The various data may include, for example, software (e.g., the program 740) and input data or output data for a command related thereto. The memory 730 may include the volatile memory 732 or the non-volatile memory 734.

The program 740 may be stored in the memory 730 as software, and may include, for example, an operating system (OS) 742, middleware 744, or an application 746.

The input module 750 may receive a command or data to be used by another component (e.g., the processor 720) of the electronic device 701, from the outside (e.g., a user) of the electronic device 701. The input module 750 may include, for example, a microphone, a mouse, a keyboard, a key (e.g., a button), or a digital pen (e.g., a stylus pen).

The sound output module 755 may output sound signals to the outside of the electronic device 701. The sound output module 755 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 760 may visually provide information to the outside (e.g., a user) of the electronic device 701. The display module 760 may include, for example, a display, a hologram device, or a projector and control circuitry to control a corresponding one of the display, hologram device, and projector. According to an embodiment, the display module 760 may include a touch sensor adapted to detect a touch, or a pressure sensor adapted to measure the intensity of force incurred by the touch.

The audio module 770 may convert a sound into an electrical signal and vice versa. According to an embodiment, the audio module 770 may obtain the sound via the input module 750, or output the sound via the sound output module 755 or a headphone of an external electronic device (e.g., an electronic device 702) directly (e.g., through at least one wire) or wirelessly coupled with the electronic device 701.

The sensor module 776 may detect an operational state (e.g., power or temperature) of the electronic device 701 or an environmental state (e.g., a state of a user) external to the electronic device 701, and then generate an electrical signal or data value corresponding to the detected state. According to an embodiment, the sensor module 776 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 777 may support one or more specified protocols to be used for the electronic device 701 to be coupled with the external electronic device (e.g., the electronic device 702) directly (e.g., through at least one wire) or wirelessly. According to an embodiment, the interface 777 may include, for example, a high definition multimedia interface (HDMI), a universal serial bus (USB) interface, a secure digital (SD) card interface, or an audio interface.

A connecting terminal 778 may include a connector via which the electronic device 701 may be physically connected with the external electronic device (e.g., the electronic device 702). According to an embodiment, the connecting terminal 778 may include, for example, an HDMI connector, a USB connector, an SD card connector, or an audio connector (e.g., a headphone connector).

The haptic module 779 may convert an electrical signal into a mechanical stimulus (e.g., a vibration or a movement) or electrical stimulus which may be recognized by a user via his tactile sensation or kinesthetic sensation. According to an embodiment, the haptic module 779 may include, for example, a motor, a piezoelectric element, or an electric stimulator.

The camera module 780 may capture a still image or moving images. According to an embodiment, the camera module 780 may include one or more lenses, image sensors, image signal processors, or flashes.

The power management module 788 may manage power supplied to the electronic device 701. According to an embodiment, the power management module 788 may be implemented as at least part of, for example, a power management integrated circuit (PMIC).

The battery 789 may supply power to at least one component of the electronic device 701. According to an embodiment, the battery 789 may include, for example, a primary cell which is not rechargeable, a secondary cell which is rechargeable, or a fuel cell.

The communication module 790 may support establishing a direct (e.g., wired) communication channel or a wireless communication channel between the electronic device 701 and the external electronic device (e.g., the electronic device 702, the electronic device 704, or the server 708) and performing communication via the established communication channel. The communication module 790 may include one or more communication processors that are operable independently from the processor 720 (e.g., the application processor (AP)) and supports a direct (e.g., wired) communication or a wireless communication. According to an embodiment, the communication module 790 may include a wireless communication module 792 (e.g., a cellular communication module, a short-range wireless communication module, or a global navigation satellite system (GNSS) communication module) or a wired communication module 794 (e.g., a local area network (LAN) communication module or a power line communication (PLC) module). A corresponding one of these communication modules may communicate with the external electronic device via the first network 798 (e.g., a short-range communication network, such as Bluetooth™, wireless-fidelity (Wi-Fi) direct, or infrared data association (IrDA)) or the second network 799 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 792 may identify and authenticate the electronic device 701 in a communication network, such as the first network 798 or the second network 799, using subscriber information (e.g., international mobile subscriber identity (IMSI)) stored in the subscriber identification module 796.

The wireless communication module 792 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 792 may support a high-frequency band (e.g., the mmWave band) to achieve, e.g., a high data transmission rate. The wireless communication module 792 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 792 may support various requirements specified in the electronic device 701, an external electronic device (e.g., the electronic device 704), or a network system (e.g., the second network 799). According to an embodiment, the wireless communication module 792 may support a peak data rate (e.g., 20 Gbps or more) for implementing eMBB, loss coverage (e.g., 764 dB or less) for implementing mMTC, or U-plane latency (e.g., 0.5 ms or less for each of downlink (DL) and uplink (UL), or a round trip of 7 ms or less) for implementing URLLC.

The antenna module 797 may transmit or receive a signal or power to or from the outside (e.g., the external electronic device) of the electronic device 701. According to an embodiment, the antenna module 797 may include an antenna including a radiating element composed of a conductive material or a conductive pattern formed in or on a substrate (e.g., a printed circuit board (PCB)). According to an embodiment, the antenna module 797 may include a plurality of antennas (e.g., array antennas). In such a case, at least one antenna appropriate for a communication scheme used in the communication network, such as the first network 798 or the second network 799, may be selected, for example, by the communication module 790 (e.g., the wireless communication module 792) from the plurality of antennas. The signal or the power may then be transmitted or received between the communication module 790 and the external electronic device via the selected at least one antenna. According to an embodiment, another component (e.g., a radio frequency integrated circuit (RFIC)) other than the radiating element may be additionally formed as part of the antenna module 797.

According to various embodiments, the antenna module 797 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 701 and the external electronic device 704 via the server 708 coupled with the second network 799. Each of the electronic devices 702 or 704 may be a device of a same type as, or a different type, from the electronic device 701. According to an embodiment, all or some of operations to be executed at the electronic device 701 may be executed at one or more of the external electronic devices 702, 704, or 708. For example, if the electronic device 701 should perform a function or a service automatically, or in response to a request from a user or another device, the electronic device 701, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 701. The electronic device 701 may provide the outcome, with or without further processing of the outcome, as at least part of a reply to the request. To that end, a cloud computing, distributed computing, mobile edge computing (MEC), or client-server computing technology may be used, for example. The electronic device 701 may provide ultra-low-latency services using, e.g., distributed computing or mobile edge computing. In another embodiment, the external electronic device 704 may include an internet-of-things (IoT) device. The server 708 may be an intelligent server using machine learning and/or a neural network. According to an embodiment, the external electronic device 704 or the server 708 may be included in the second network 799. The electronic device 701 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., through at least one wire), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 740) including one or more instructions that are stored in a storage medium (e.g., internal memory 736 or external memory 738) that is readable by a machine (e.g., the electronic device 701). For example, a processor (e.g., the processor 720) of the machine (e.g., the electronic device 701) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added. The electronic device 701 of FIG. 7 may be an example of the electronic device described with reference to FIGS. 1 to 6. For example, the processor 720 of FIG. 7 may correspond to the processor 210 of FIG. 2. A sensor hub may be a controller included in the sensor module 776 of FIG. 7, or the processor 720 of FIG. 7, or may correspond to the auxiliary processor 723 of FIG. 7. The memory 730 of FIG. 7 may correspond to the memory 215 of FIG. 2. The power management module 788 of FIG. 7 may correspond to the power circuitry 230 of FIG. 2. The communication module 790 of FIG. 7 may correspond to the communication circuitry 235 of FIG. 2. The sensor module 776 of FIG. 7 may correspond to the sensor 220 of FIG. 2.

In an embodiment, a method for performing calibration of a geomagnetic sensor by using sensor data of a gyro sensor may be required. In an embodiment, according to states of the geomagnetic sensor and/or the gyro sensor, a method for dynamically performing the calibration of the geomagnetic sensor may be required. As described above, according to an embodiment, an electronic device (e.g., the electronic device 101 of FIG. 1 and/or the electronic device 701 of FIG. 7) may comprise a geomagnetic sensor (e.g., the geomagnetic sensor 221 of FIG. 2), a gyro sensor (e.g., the gyro sensor 222 of FIG. 2), memory (e.g., the memory 215 of FIG. 2) storing instructions, and a processor (e.g., the processor 210 of FIG. 2). The instructions, when executed by the processor, may cause the electronic device to determine whether to change calibration information to be applied to sensor data of the geomagnetic sensor. The instructions, when executed by the processor, may cause the electronic device to, based on a determination to change the calibration information, identify a state of the geomagnetic sensor and a state of the gyro sensor. The instructions, when executed by the processor, may cause the electronic device to, based on identifying the state of the geomagnetic sensor corresponding to an activated state and identifying the state of the gyro sensor corresponding to a deactivated state, change the calibration information by using distribution of directions of a magnetic field that was measured by the geomagnetic sensor. The instructions, when executed by the processor, may cause the electronic device to, based on identifying the states of the geomagnetic sensor corresponding to the activated state and the gyro sensor corresponding to the activated state, change the calibration information by using directions of a magnetic field that were measured by the geomagnetic sensor and a rotation angle of the electronic device that was measured by the gyro sensor at moments when the directions were measured. According to an embodiment, the electronic device may more quickly perform calibration of the geomagnetic sensor using the sensor data of the gyro sensor. According to an embodiment, the electronic device may dynamically perform the calibration of the geomagnetic sensor according to the states of the geomagnetic sensor and/or the gyro sensor.

For example, the instructions, when executed by the processor, may cause the electronic device to determine whether to change the calibration information by using a parameter associated with a state of a user of the electronic device.

For example, the instructions, when executed by the processor, may cause the electronic device to determine whether to change the calibration information by using a position of the electronic device that is identified by using a global positioning system (GPS) sensor.

For example, the instructions, when executed by the processor, may cause the electronic device to determine whether to change the calibration information based on whether a software application executed by the processor is associated with the geomagnetic sensor.

For example, the instructions, when executed by the processor, may cause the electronic device to determine to change the calibration information per a preset period.

For example, the instructions, when executed by the processor, may cause the electronic device to change the preset period based on a state of charge (SOC) of a battery of the electronic device.

For example, the electronic device may comprise a display (e.g., the display 110 of FIGS. 1 and/or 2). The instructions, when executed by the processor, may cause the electronic device to, while the geomagnetic sensor is switched into the activated state by a foreground software application occupying the display, identify the state of the gyro sensor.

For example, the instructions, when executed by the processor, may cause the electronic device to, in response to the state of the geomagnetic sensor corresponding to the deactivated state, bypass changing the calibration information.

For example, the instructions, when executed by the processor, may cause the electronic device to, based on identifying the state of the geomagnetic sensor corresponding to the activated state and based on identifying the state of the gyro sensor corresponding to the deactivated state, determine, from the directions represented by three-dimensional vectors, a center point (e.g., the center point c1 of FIGS. 4 and/or 5) of a spherical surface at which the three-dimensional vectors are positioned. The instructions, when executed by the processor, may cause the electronic device to store a three-dimensional vector representing the determined center point as the calibration information.

For example, the instructions, when executed by the processor, may cause the electronic device to, based on identifying that the state of the geomagnetic sensor and the state of the gyro sensor correspond to the activated state, obtain, by using the rotation angle, a plurality of circles (e.g., the circles 510 and 520 of FIG. 5) where three-dimensional vectors representing the directions are positioned. The instructions, when executed by the processor, may cause the electronic device to change the calibration information by using a center point of a spherical surface including the plurality of circles.

For example, the instructions, when executed by the processor, may cause the electronic device to, after changing the calibration information, generate the sensor data to which the calibration information is combined in response to an event to access the sensor data of the geomagnetic sensor.

As described above, in an embodiment, a method of an electronic device including a geomagnetic sensor and a gyro sensor may be provided. The method may comprise determining whether to change calibration information to be applied to sensor data of the geomagnetic sensor (e.g., the operation 310 of FIG. 3). The method may comprise, based on a determination to change the calibration information, identifying the state of the geomagnetic sensor and the state of the gyro sensor (e.g., the operations 320 and 330 of FIG. 3). The method may comprise, based on identifying the state of the geomagnetic sensor corresponding to an activated state and identifying the state of the gyro sensor corresponding to a deactivated state, changing the calibration information by using distribution of directions of a magnetic field that was measured by the geomagnetic sensor (e.g., the operation 350 of FIG. 3). The method may comprise, based on identifying the states of the geomagnetic sensor corresponding to the activated state and the gyro sensor corresponding to the activated state, changing the calibration information by using directions of a magnetic field that were measured by the geomagnetic sensor and a rotation angle of the electronic device that was measured by the gyro sensor at moments when the directions were measured (e.g., the operation 340 of FIG. 3).

For example, the determining may comprise determining whether to change the calibration information by using a parameter associated with a state of a user of the electronic device.

For example, the determining may comprise determining whether to change the calibration information by using a position of the electronic device that is identified by using a global positioning system (GPS) sensor.

For example, the determining may comprise determining whether to change the calibration information based on whether a software application executed by a processor of the electronic device is associated with the geomagnetic sensor.

For example, the determining may comprise determining to change the calibration information per a preset period.

For example, the method may comprise changing the preset period based on a state of charge (SOC) of a battery of the electronic device.

For example, the identifying may comprise, while the geomagnetic sensor is switched into the activated state by a foreground software application occupying the display, identifying the state of the gyro sensor.

For example, the method may comprise, in response to the state of the geomagnetic sensor corresponding to the deactivated state, bypassing changing the calibration information.

For example, the changing the calibration information by using the distribution may comprise, determining, from the directions represented by three-dimensional vectors, a center point of a spherical surface at which the three-dimensional vectors are positioned. The method may comprise storing a three-dimensional vector representing the determined center point as the calibration information.

For example, the changing the calibration information by using the directions and the rotation angle may comprise, based on identifying that the state of the geomagnetic sensor and the state of the gyro sensor correspond to the activated state, obtaining, by using the rotation angle, a plurality of circles where three-dimensional vectors representing the directions are positioned. The method may comprise changing the calibration information by using a center point of a spherical surface including the plurality of circles.

For example, the method may comprise, after changing the calibration information, generating the sensor data to which the calibration information is combined in response to an event to access the sensor data of the geomagnetic sensor.

As described above, in an embodiment, a non-transitory computer readable storage medium including instructions may be provided. The instructions, when executed by a processor of an electronic device including a geomagnetic sensor and a gyro sensor, may cause the electronic device to determine whether to change calibration information to be applied to sensor data of the geomagnetic sensor. The instructions, when executed by the processor, may cause the electronic device to, based on a determination to change the calibration information, identify a state of the geomagnetic sensor and a state of the gyro sensor. The instructions, when executed by the processor, may cause the electronic device to, based on identifying the state of the geomagnetic sensor corresponding to an activated state and identifying the state of the gyro sensor corresponding to a deactivated state, change the calibration information by using distribution of directions of a magnetic field that was measured by the geomagnetic sensor. The instructions, when executed by the processor, may cause the electronic device to, based on identifying the states of the geomagnetic sensor corresponding to the activated state and the gyro sensor corresponding to the activated state, change the calibration information by using directions of a magnetic field that were measured by the geomagnetic sensor and a rotation angle of the electronic device that was measured by the gyro sensor at moments corresponding to the activated state.

The device described above may be implemented as a hardware component, a software component, and/or a combination of a hardware component and a software component. For example, the devices and components described in the embodiments may be implemented by using one or more general purpose computers or special purpose computers, such as a processor, controller, arithmetic logic unit (ALU), digital signal processor, microcomputer, field programmable gate array (FPGA), programmable logic unit (PLU), microprocessor, or any other device capable of executing and responding to instructions. The processing device may perform an operating system (OS) and one or more software applications executed on the operating system. In addition, the processing device may access, store, manipulate, process, and generate data in response to the execution of the software. For convenience of understanding, there is a case that one processing device is described as being used, but a person who has ordinary knowledge in the relevant technical field may see that the processing device may include a plurality of processing elements and/or a plurality of types of processing elements. For example, the processing device may include a plurality of processors or one processor and one controller. In addition, another processing configuration, such as a parallel processor, is also possible.

The software may include a computer program, code, instruction, or a combination of one or more thereof, and may configure the processing device to operate as desired or may command the processing device independently or collectively. The software and/or data may be embodied in any type of machine, component, physical device, computer storage medium, or device, to be interpreted by the processing device or to provide commands or data to the processing device. The software may be distributed on network-connected computer systems and stored or executed in a distributed manner. The software and data may be stored in one or more computer-readable recording medium.

The method according to the embodiment may be implemented in the form of a program command that may be performed through various computer means and recorded on a computer-readable medium. In this case, the medium may continuously store a program executable by the computer or may temporarily store the program for execution or download. In addition, the medium may be various recording means or storage means in the form of a single or a combination of several hardware, but is not limited to a medium directly connected to a certain computer system, and may exist distributed on the network. Examples of media may include a magnetic medium such as a hard disk, floppy disk, and magnetic tape, optical recording medium such as a CD-ROM and DVD, magneto-optical medium, such as a floptical disk, and those configured to store program instructions, including ROM, RAM, flash memory, and the like. In addition, examples of other media may include recording media or storage media managed by app stores that distribute applications, sites that supply or distribute various software, servers, and the like.

Although the embodiments have been described above with reference to limited examples and drawings, various modifications and variations may be made from the above description by those skilled in the art. For example, even if the described technologies are performed in a different order from the described method, and/or the components of the described system, structure, device, circuit, and the like are coupled or combined in a different form from the described method, or replaced or substituted by other components or equivalents, appropriate a result may be achieved.

Therefore, other implementations, other embodiments, and those equivalent to the scope of the claims are in the scope of the claims described later.

No claim element is to be construed under the provisions of 35 U.S.C. § 112, sixth paragraph, unless the element is expressly recited using the phrase “means for” or “means.”

What is claimed is:

1. An electronic device comprising:
a geomagnetic sensor;
a gyro sensor;
memory including one or more storage media storing instructions; and
at least one processor including processing circuitry, wherein the instructions, when executed by the at least one processor individually or collectively, cause the electronic device to:
determine whether to change calibration information to be applied to sensor data of the geomagnetic sensor;
based on a determination to change the calibration information, identify a state of the geomagnetic sensor and a state of the gyro sensor;
based on identifying that the state of the geomagnetic sensor corresponds to an activated state and identifying that the state of the gyro sensor corresponds to a deactivated state, change the calibration information at a first time point by using distribution of directions of a magnetic field, which are measured by the geomagnetic sensor at a second time point that is prior to the first time point;
based on identifying that the state of the geomagnetic sensor corresponds to the activated state and identifying that the gyro sensor corresponds to the activated state, change the calibration information by using the directions of the magnetic field and by using a rotation angle of the electronic device, which is measured by the gyro sensor at the second time point.

2. The electronic device of claim 1, wherein the instructions, when executed by the at least one processor individually or collectively, further cause the electronic device to determine whether to change the calibration information by using a parameter associated with a state of a user of the electronic device.

3. The electronic device of claim 1, wherein the instructions, when executed by the at least one processor individually or collectively, further cause the electronic device to determine whether to change the calibration information by using a position of the electronic device, which is identified by using a global positioning system (GPS) sensor.

4. The electronic device of claim 1, wherein the instructions, when executed by the at least one processor individually or collectively, cause the electronic device to determine whether to change the calibration information based on a determination of whether a software application is associated with the geomagnetic sensor, and
wherein the software application is executed by the at least one processor.

5. The electronic device of claim 1, wherein the instructions, when executed by the at least one processor individually or collectively, further cause the electronic device to determine to change the calibration information per a preset period.

6. The electronic device of claim 5, wherein the instructions, when executed by the at least one processor individually or collectively, further cause the electronic device to change the preset period based on a state of charge (SOC) of a battery of the electronic device.

7. The electronic device of claim 1, further comprising a display,
wherein the instructions, when executed by the at least one processor individually or collectively, further cause the electronic device to, while the geomagnetic sensor is switched into the activated state by a foreground software application occupying the display, identify the state of the gyro sensor.

8. The electronic device of claim 1, wherein the instructions, when executed by the at least one processor individually or collectively, further cause the electronic device to, based on the state of the geomagnetic sensor corresponding to the deactivated state, bypass changing the calibration information.

9. The electronic device of claim 1, wherein the instructions, when executed by the at least one processor individually or collectively, further cause the electronic device to:
based on identifying that the state of the geomagnetic sensor corresponds to the activated state and based on identifying that the state of the gyro sensor corresponds to the deactivated state, determine, from the directions represented by three-dimensional vectors, a center point of a spherical surface at which the three-dimensional vectors are positioned;
store a three-dimensional vector representing the determined center point as the calibration information.

10. The electronic device of claim 1, wherein the instructions, when executed by the at least one processor individually or collectively, further cause the electronic device to:
based on that identifying the state of the geomagnetic sensor and the state of the gyro sensor correspond to the activated state, obtain, by using the rotation angle, a plurality of circles where three-dimensional vectors representing the directions are positioned;
change the calibration information by using a center point of a spherical surface including the plurality of circles.

11. The electronic device of claim 1, wherein the instructions, when executed by the at least one processor individually or collectively, further cause the electronic device to, after changing the calibration information, generate the sensor data to which the calibration information is combined in response to an event to access the sensor data of the geomagnetic sensor.

12. A method of an electronic device including a geomagnetic sensor and a gyro sensor, comprising:
determining whether to change calibration information to be applied to sensor data of the geomagnetic sensor;
based on a determination to change the calibration information, identifying a state of the geomagnetic sensor and a state of the gyro sensor;
based on identifying that the state of the geomagnetic sensor corresponds to an activated state and identifying that the state of the gyro sensor corresponds to a deactivated state, changing the calibration information at a first time point by using distribution of directions of a magnetic field, which are measured by the geomagnetic sensor at a second time point that is prior to the first time point;
based on identifying that the state of the geomagnetic sensor corresponds to the activated state and identifying that the gyro sensor corresponds to the activated state, changing the calibration information by using the directions of the magnetic field and by using a rotation angle of the electronic device, which is measured by the gyro sensor at the second time point.

13. The method of claim 12, wherein the determining whether to change the calibration information comprises determining whether to change the calibration information by using a parameter associated with a state of a user of the electronic device.

14. The method of claim 12, wherein the determining whether to change the calibration information comprises determining whether to change the calibration information by using a position of the electronic device, which is identified by using a global positioning system (GPS) sensor.

15. The method of claim 12, wherein the determining whether to change the calibration information comprises determining whether to change the calibration information based on a determination of whether a software application is associated with the geomagnetic sensor, and
wherein the software application is executed by a processor of the electronic device.

16. The method of claim 12, wherein the determining whether to change the calibration information comprises determining to change the calibration information per a preset period.

17. The method of claim 16, further comprising changing the preset period based on a state of charge (SOC) of a battery of the electronic device.

18. The method of claim 12, wherein the identifying the state of the geomagnetic sensor and the state of the gyro sensor comprises, while the geomagnetic sensor is switched into the activated state by a foreground software application occupying the display, identifying the state of the gyro sensor.

19. The method of claim 12, further comprising, based on the state of the geomagnetic sensor corresponding to the deactivated state, bypassing changing the calibration information.

20. A non-transitory computer readable storage medium including instructions, wherein the instructions, when executed by a processor of an electronic device including a geomagnetic sensor and a gyro sensor, cause the electronic device to:
determine whether to change calibration information to be applied to sensor data of the geomagnetic sensor;
based on a determination to change the calibration information, identify a state of the geomagnetic sensor and a state of the gyro sensor;
based on identifying that the state of the geomagnetic sensor corresponds to an activated state and identifying that the state of the gyro sensor corresponds to a deactivated state, change the calibration information at a first time point by using distribution of directions of a magnetic field, which are measured by the geomagnetic sensor at a second time point that is prior to the first time point;
based on identifying that the state of the geomagnetic sensor corresponds to the activated state and identifying that the state of the gyro sensor corresponds to the activated state, change the calibration information by using the directions of the magnetic field and by using a rotation angle of the electronic device, which is measured by the gyro sensor at the second time point.
